(19) United States
(12) Patent Application Publication
(10) Pub. No.: US 2001/0046457 A1
(43) Pub. Date: Nov. 29, 2001

(54) Catalytic converter

(76) Inventors: Said Zidat, Thionville (FR); Steve Mayes, Canach (FR); Jos Verbeeck, Petange (FR)

Correspondence Address: VINCENT A. CICHOSZ, DELPHI TECHNOLOGIES, INC., Legal Staff, Mail Code: 480-414-420, P.O. Box 5052, Troy, MI, 48007-5052, US

(21) Appl. No.: 09/850,822

(22) Filed: May 8, 2001

(30) Foreign Application Priority Data
May 19, 2000 (LU) 90 586

(51) Int. Cl. B01D 50/00; F01N 3/00

(52) U.S. Cl. 422/179; 422/168

(57) ABSTRACT

A catalytic converter (110) comprises a converter shell (112), at least one tapered end piece (114) with a flange (116) and thermal shield (122). Said thermal shield (122) extends in an axial direction from said converter shell (122) and said thermal shield (122) surrounds said end piece (114) and said flange (116) on at least a part of the periphery of said converter (110).

### INTRODUCTION

The present invention relates to catalytic converters for internal combustion engine exhaust systems and, in particular, to a highly heat insulated catalytic converter.

It is known in the art relating to vehicle engine exhaust catalytic converters for controlling exhaust emissions to provide a housing including an insulated cylindrical shell to which tapered end piece assemblies comprising a flange are welded for connecting the converter to associated exhaust pipes or components. A catalytic element is assembled into the cylindrical shell prior to installing and welding the end cone assemblies on to the shell. The shell may have a circular cross section or be of any suitable non-circular configuration.

During operation of the engine, the internal combustion engine exhaust gases pass through the converter, so that the converter is heated to high temperatures. In order to reduce the heat radiation emanating from the shell of the catalytic converter, the metallic or ceramic monolith is mounted within the catalyst shell by a heat-insulating blanket, which can comprise a mat of refractory ceramic fibres.

However, the use of a dual cone for the end piece and the usage of the insulation fibres in between are of limited value. In fact, although the outer wall is insulated from the inner wall by an air gap of a fibre mat, the outer wall nevertheless is heated by radiation and conduction of the flange, where the two walls of the end piece are assembled together. Furthermore, the flange itself is an important source of heat.

### OBJECT OF THE INVENTION

The object of the present invention is to provide a catalytic converter having an improved thermal insulation.

### GENERAL DESCRIPTION OF THE INVENTION

In order to overcome the abovementioned problems, the present invention provides a catalytic converter, comprising a converter shell, at least one tapered end piece with a flange and a thermal shield, said thermal shield extending in an axial direction from said converter shell and said thermal shield surrounding said end piece and said flange on at least a part of the periphery of said converter.

The thermal shield of the catalytic converter forms an outer shell of the tapered end piece and the mounting flange. This outer shell extends at least on a part of the periphery of the converter and accordingly of a part of the periphery of the tapered end and the flange. Thus the thermal shield blocks the heat radiation emanating from the surrounded part of the tapered end piece and the flange, thereby protecting the vehicle floor or any engine elements lying beyond said thermal shield. The thermal shield extends preferably beyond the outer flange, so that the heat radiation from the flange itself can be effectively blocked. It will be appreciated, that heat conduction from the flange towards the thermal shield is not possible, since the thermal shield is not assembled to the flange.

It has to be noted that the thermal shield can surround said tapered end piece and said flange on the entire radial periphery of said converter. In the case, the thermal shield comprises a sort of pipe having a section substantially equal to the section of the converter shell. In an alternative embodiment, the thermal shield surrounds only a part of the periphery of the tapered end and the flange. In this case the thermal shield comprises only a section of a pipe and is arranged on the periphery of the converter in a region, which is oriented towards the critical engine or vehicle parts.

It will be appreciated, that in either case, the thermal shield represents a very effective heat insulation, combining effectiveness with low production costs. In fact, the thermal shield, especially when surrounding the entire periphery of said end piece, provides a better heat insulation than a dual cone assembly, the manufacturing of which requires expensive tooling. It follows that for an even better heat insulation as compared to prior art converters, the end piece of the catalytic converter of the present invention does not need to be a dual cone assembly, thus reducing the production costs for the converter.

The thermal shield can be a separate part, which is welded to the converter shell. In a more preferred embodiment, the thermal shield is however an integral part of said converter shell. In other words, the converter shell is designed so as to extend at least on a part of its periphery beyond the catalytic element or the heat-insulating blanket and the inner end is assembled, e.g. welded, onto an inner surface of the projecting end of the shell, i.e. of said thermal shield. It will be appreciated that this embodiment represents a very simple concept for providing the thermal shield on the catalytic converter.

In a very simple embodiment, the tapered end piece comprises a simple cone which is welded onto the inner surface of said thermal shield respectively of said converter shell. In order to provide a stop means for the heat insulating blanket between the catalytic element and the converter shell, the tapered end piece comprises preferably a bread on its inner end, said bread extending radially outwardly and having an outer periphery which is substantially equal in shape and size to an inner surface of said thermal shield. In this embodiment, the axially outer of the peripheral bread can act as a stopper for said insulating blanket. Furthermore, due to the bread, the opening angle of the end cone itself is reduced in this embodiment. This improves the accessibility of the connection between the tapered end piece and the inner surface of the converter shell, thus simplifying the assembly of the two part e.g. by welding.

If an improved heat insulation is required due to the mounting of the catalytic converter at a critical location, the tapered end piece can comprise a double wall cone assembly with an outer cone and an inner cone, said inner cone being arranged coaxially within said outer cone. Furthermore an insulation material is preferably arranged within a gap between said inner cone and said outer cone of said tapered end piece. Although this embodiment increases the production costs due to the double cone assembly, it nevertheless provides unequalled head insulation.

In a simpler embodiment with improved insulation properties, said thermal shield comprises a double wall assembly with an outer wall and an inner wall, said inner wall being arranged coaxially within said outer wall and said outer wall and said inner wall being mounted together on an outer end of said thermal shield. In this embodiment, the outer wall of said thermal shield could be an integral part of said converter shell and the inner wall could be mounted, e.g. welded or dimpled, on the outer extremity of said outer inner wall. It has to be noted that this embodiment is easy to assemble, since the end cone assembly can be assembled to the inner wall the of the thermal shield before the insertion into the converter shell. This means that the welding of the end piece and the inner wall takes place outside of the converter shell, so that the weldment joint is easily accessible. After the two pieces are mounted together, they can be axially introduced into the projecting end of the converter shell and the inner wall is subsequently assembled to the outer extremity of the outer wall. Here again the weldment joint is easily accessible.

In order to further improve the insulation properties of the thermal shield, an insulation material is preferably arranged within a gap between said inner wall and said outer wall of said thermal shield. The insulation material can e.g. be a part of the heat-insulating blanket arranged between the catalytic element and the said converter shell.

### DETAILED DESCRIPTION WITH RESPECT TO THE FIGURES

The present invention will be more apparent from the following description of not limiting embodiment with reference to the attached drawings, wherein

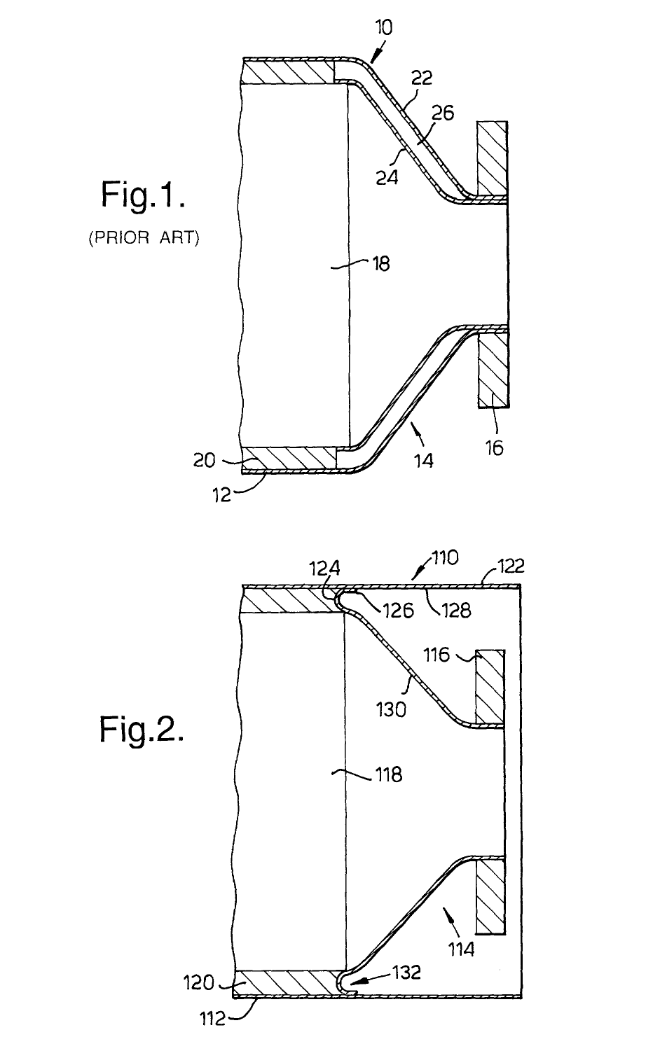

FIG. 1 shows one end of a prior art catalytic converter;

FIG. 2 shows a part of a first embodiment of an improved converter;

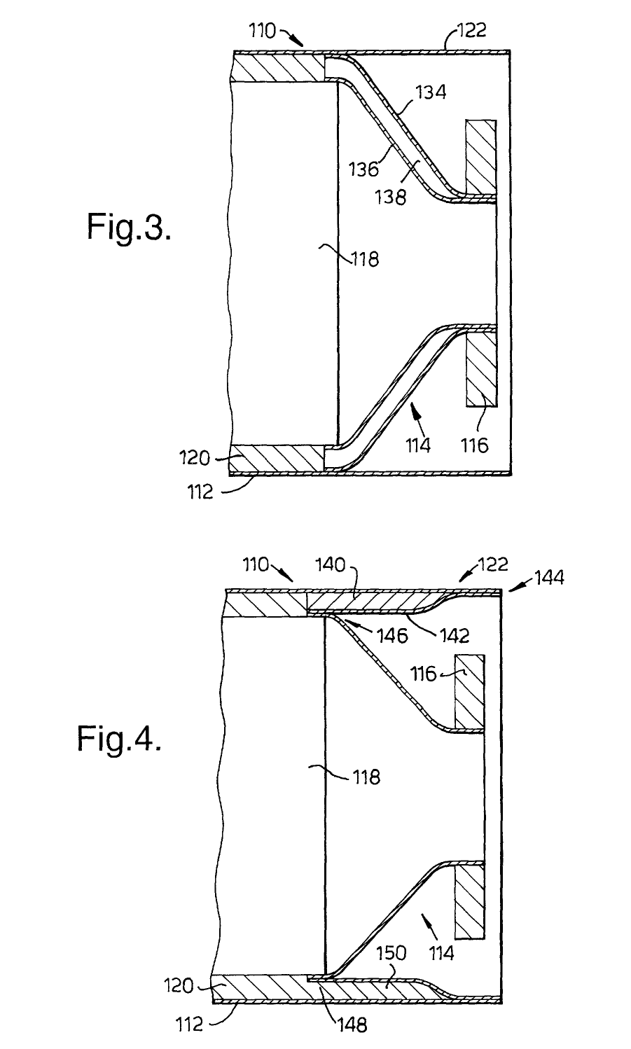

FIG. 3 shows a part of a second embodiment of a an improved converter;

FIG. 4 shows a part of third embodiment of an improved converter.

FIG. 1 shows one end of a conventional catalytic converter. It comprises a converter shell 12 to which a tapered end piece 14 comprising a flange 16 is welding for connecting the converter to associated exhaust pipes or components. A catalytic element 18 is assembled into the converter shell 12 prior to installing and welding the end cone assembly 14 on to the shell. In order to reduce the heat radiation emanating from the shell 12 of the catalytic converter 10, the catalytic element 18 is mounted within the catalyst shell by a heat-insulating blanket 20, which can comprise a mat of refractory ceramic fibres. Furthermore, the tapered end piece 14 comprises a double wall cone assembly, with an outer cone 22 and an inner cone 24. The inner cone is arranged coaxially inside said outer cone 22 and the space between the two cones is filled with insulation fibres 26.

While the double cone assembly substantially reduces the heat radiation with respect to a single cone end piece, this assembly nevertheless can not prevent the outer cone from heating up due to heat conduction from the flange 16, where the inner and outer cone are assembled together. Furthermore, the flange itself is an important source of heat.

FIG. 2 shows a first embodiment of an improved catalytic converter 110 according to the present invention. Like the prior art converter, the converter 110 comprises a converter shell 112 to which a tapered end piece 114 comprising a flange 116 is welded for connecting the converter to associated exhaust pipes or components. The shell 112 may have a circular cross section or be of any suitable non-circular configuration. A catalytic element 118 is assembled into the converter shell 112 prior to installing and welding the end cone assembly 114 on to the shell. In order to reduce the heat radiation emanating from the shell 112 of the catalytic converter 110, the catalytic element 118 is mounted within the catalyst shell by a heat-insulating blanket 120, which can comprise a mat of refractory ceramic fibres.

In order to remove the deficiency of the prior art converter, the present converter 110 comprises a thermal shield 122, which extends in an axial direction from the converter shell 112 and surrounds the end piece 114 and the flange 116 at least on a part of their periphery. The thermal shield preferably extends beyond the flange 116, so that the flange 116 is entirely shielded.

The thermal shield 122 is preferably an integral part of the converter shell 112. The tapered end piece is then inserted into the projecting end of the converter shell 122, i.e. the thermal shield 122, until its inner end 124 abuts against the catalytic element 116 or the heat-insulating blanket 120. Subsequently the end piece 114 is assembled, e.g. welded 126, onto an inner surface 128 of the projecting end of the converter shell, i.e. of said thermal shield. It will be appreciated that this embodiment represents a very simple concept for providing the thermal shield on the catalytic converter.

In the embodiment shown in FIG. 2, the tapered end piece 114 comprises a single cone 130 which is welded onto the inner surface 128 of said thermal shield 122. The cone 130 preferably comprises a bread 132 on its inner end, which extends radially outwardly and which has an outer periphery which is substantially equal in shape and size to the section of the inner surface of said thermal shield 122. In this embodiment, the axially outer surface 124 of the peripheral bread 132 can act as a stopper for said insulating blanket 120.

A second embodiment of an improved catalytic converter is shown in FIG. 3. In this embodiment, the tapered end piece 114 comprises a double wall cone assembly with an outer cone 134 and an inner cone 136, said inner cone 136 being arranged coaxially within said outer cone 134. Furthermore an insulation material 138 is preferably arranged within a gap between said inner cone 136 and said outer cone 134 of said tapered end piece 114. Although this embodiment increases the production costs due to the double cone assembly, it nevertheless provides unequalled heat insulation.

Another embodiment of the present invention with improved properties is represented in FIG. 4. In this variant, said thermal shield 122 comprises a double wall assembly with an outer wall 140 and an inner wall 142, said inner wall 142 being arranged coaxially within said outer wall 140. The outer wall 140 and the inner wall 142 are mounted together on an outer end 144 of said thermal shield 122 can be an integral part of said converter shell 122 and the inner wall 142 could be mounted, e.g. welded or dimpled, on the outer extremity of said outer wall 140.

The end cone assembly 114 is mounted 146 on an inner end 148 of said inner wall 142. An insulation material 150 is arranged within a gap between said inner wall 142 and said outer wall 140 of said thermal shield 122. The insulation material 150 can e.g. be a part of the heat-insulating blanket 120 arranged between the catalytic element 118 and said converter shell 112.

1. Catalytic converter (110), comprising a converter shell (112) and at least one tapered end piece (114) with a flange (116), characterised by a thermal shield (122), said thermal shield (122) and said thermal shield (122) surrounding said end piece (114) and said flange (116) on at least a part of the periphery of said converter (110).

2. Catalytic converter according to claim 1, wherein said thermal shield is an integral part of said converter shell (112).

3. Catalytic converter according to claim 1 or 2, wherein said tapered end piece (114) is assembled to an inner surface (128) of said thermal shield (122).

4. Catalytic converter according to claim 3, wherein said tapered end piece (114) comprises an inner end facing said converter shell (112) and an outer end terminating at said flange (116), characterised in that said tapered end piece (114) comprises a bread (132) on its inner end, said bread (132) extending radially outwardly and having an outer periphery which is substantially equal in shape and size to a section of an inner surface (128) of said thermal shield (122).

5. Catalytic converter according to any one of the claims 1 to 4, wherein said tapered end piece (114) comprises a double wall cone assembly with an outer cone (134) and an inner cone (136) being arranged coaxially within said outer cone (134).

6. Catalytic converter according to claim 5, comprising an insulation material (138) arranged within a gap between said inner cone (136) and said outer cone (134) of said tapered end piece (114).

7. Catalytic converter according to any one of claims 1 to 6, wherein said thermal shield (122) comprises a double wall assembly with an outer wall (140) and an inner wall (142), said inner wall (142) being arranged coaxially within said outer wall (140) and said outer wall (140) and said inner wall (142) being mounted together on an outer end (144) of said thermal shield (122).

8. Catalytic converter according to claim 7, wherein said outer wall (140) of said thermal shield (122) is an integral part of said converter shell (122), and wherein said end tapered end piece (114) is mounted on an inner end (148) of said inner wall (142).

9. Catalytic converter according to claim 7 or 8, comprising an insulation material (150) arranged within a gap between said inner wall (142) and said outer wall (140) of said thermal shield (122).
